(19) United States
(12) Patent Application Publication
(10) Pub. No.: US 2026/0295426 A1
(43) Pub. Date: Oct. 1, 2026

(54) NON-TRANSITORY COMPUTER-READABLE STORAGE MEDIA, SYSTEM, AND COMPUTER-IMPLEMENTED METHOD

(71) Applicant: NINTENDO CO., LTD., Kyoto-shi (JP)

(72) Inventors: Toshiaki SUZUKI, Kyoto-shi (JP); Satoshi EZAKI, Tokyo (JP); Yuya KUMAGAI, Tokyo (JP)

(21) Appl. No.: 19/575,519

(22) Filed: Mar. 23, 2026

(30) Foreign Application Priority Data
Mar. 25, 2025 (JP) 2025-050280

(51) Int. Cl. A63F 13/655; A63F 13/213; A63F 13/53; A63F 13/87

(52) U.S. Cl. CPC A63F 13/655; A63F 13/213; A63F 13/53; A63F 13/87

(57) ABSTRACT

One or more non-transitory computer-readable storage media having stored therein instructions for game processing are provided. The instructions, when executed, cause one or more processors to perform operations including obtaining chat camera video data to be used for generation of chat cut-out video resulting from cut-out of a person from camera footage, the chat cut-out video being shown while a chat application is running, and generating a game cut-out video resulting from cut-out of the person from the camera footage based on the chat camera video data, the game cut-out video being shown while a game program is running. Jagged artifacts along a contour of the person are suppressed in the game cut-out video relative to the chat cut-out video.

This non-provisional application is based on Japanese Patent Application No. 2025-050280 filed with the Japan Patent Office on Mar. 25, 2025, the entire contents of which are hereby incorporated by reference.

### FIELD

The present disclosure relates to a game program, a system, and a method.

### BACKGROUND AND SUMMARY

A system that shows, together with a game image, video which is captured by a camera and may include a user has been known.

There is room for improvement in processing for showing an image of a user together with an image of a game.

(Configuration 1) An exemplary embodiment provides one or more non-transitory computer-readable storage media having stored therein instructions for game processing. The instructions, when executed, cause one or more processors to perform operations including obtaining chat camera video data to be used for generation of chat cut-out video resulting from cut-out of a person from camera footage, the chat cut-out video being shown while a chat application is running, and generating game cut-out video resulting from cut-out of the person from the camera footage based on the chat camera video data, the game cut-out video being shown while a game program is running. Jagged artifacts along a contour of the person are suppressed in the game cut-out video relative to the chat cut-out video.

(Configuration 2) In Configuration 1, the game cut-out video may be based on footage captured by a camera available to an information processing apparatus that executes the instructions.

(Configuration 3) In Configuration 1 or 2, the game cut-out video may be based on chat camera video data obtained by an information processing apparatus that executes the instructions, from another information processing apparatus with which the information processing apparatus communicates while the chat application is running.

(Configuration 4) In Configuration 3, the operations may include obtaining positional information from the another information processing apparatus, generating, based on the chat camera video data, yet-to-be-corrected video from which the person has been cut out, the yet-to-be-corrected video corresponding to a display area indicated by the positional information, and generating the game cut-out video by performing processing for suppressing jagged artifacts on the yet-to-be-corrected video.

(Configuration 5) In any of Configurations 1 to 4, a display area for a game image including the game cut-out video may be larger than each display area for the chat cut-out video.

(Configuration 6) An exemplary embodiment provides a system that includes one or more processors and one or more memories having stored therein instructions for game processing. The instructions, when executed, cause the system to perform operations including obtaining chat camera video data to be used for generation of chat cut-out video resulting from cut-out of a person from camera footage and generating game cut-out video resulting from cut-out of the person from the camera footage based on the chat camera video data, the game cut-out video being shown while a game program is running. Jagged artifacts along a contour of the person are suppressed in the game cut-out video relative to the chat cut-out video.

(Configuration 7) In Configuration 6, the game cut-out video may be based on footage captured by a camera available to the system.

(Configuration 8) In Configuration 6 or 7, the game cut-out video may be based on chat camera video data obtained by the system from another information processing apparatus with which the system communicates while a chat application is running.

(Configuration 9) In Configuration 8, the operations may include obtaining positional information from the another information processing apparatus, generating, based on the chat camera video data, yet-to-be-corrected video from which the person has been cut out, the yet-to-be-corrected video corresponding to a display area indicated by the positional information, and generating the game cut-out video by performing processing for suppressing jagged artifacts on the yet-to-be-corrected video.

(Configuration 10) In any of Configurations 6 to 9, a display area for a game image including the game cut-out video may be larger than each display area for the chat cut-out video.

(Configuration 11) An exemplary embodiment provides a computer-implemented method that includes performing game processing in accordance with a game program, obtaining chat camera video data to be used for generation of chat cut-out video resulting from cut-out of a person from camera footage, the chat cut-out video being shown while a chat application is running, and generating game cut-out video resulting from cut-out of the person from the camera footage based on the chat camera video data, the game cut-out video being shown while the game program is running. Jagged artifacts along a contour of the person are suppressed in the game cut-out video relative to the chat cut-out video.

(Configuration 12) In Configuration 11, the game cut-out video may be based on footage captured by a camera available to a computer.

(Configuration 13) In Configuration 11, the game cut-out video may be based on chat camera video data obtained by the computer from another computer with which the computer communicates while the chat application is running.

(Configuration 14) In Configuration 13, the computer-implemented method may include obtaining positional information from the another computer, generating, based on the chat camera video data, yet-to-be-corrected video from which the person has been cut out, the yet-to-be-corrected video corresponding to a display area indicated by the positional information, and generating the game cut-out video by performing processing for suppressing jagged artifacts on the yet-to-be-corrected video.

(Configuration 15) In any of Configurations 11 to 14, a display area for a game image including the game cut-out video may be larger than each display area for the chat cut-out video.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows an exemplary illustrative non-limiting drawing illustrating an exemplary configuration of a system according to the present embodiment.

FIG. 2 shows an exemplary illustrative non-limiting drawing illustrating an exemplary hardware configuration of a game device according to the present embodiment.

FIG. 3 shows an exemplary illustrative non-limiting drawing illustrating an exemplary software configuration of the game device according to the present embodiment.

FIGS. 4A to 4C each show an exemplary illustrative non-limiting drawing illustrating an exemplary camera video display mode in the game device according to the present embodiment.

FIGS. 5A to 5C each show an exemplary illustrative non-limiting drawing visually illustrating exemplary mask data in the game device according to the present embodiment.

FIGS. 6A and 6B each show an exemplary illustrative non-limiting drawing illustrating an exemplary chat screen generated in the game device according to the present embodiment.

FIG. 7 shows an exemplary illustrative non-limiting drawing illustrating an exemplary setting screen provided in the game device according to the present embodiment.

FIGS. 8A and 8B each show an exemplary illustrative non-limiting drawing illustrating exemplary camera video that has been subjected to cut-out processing in the game device according to the present embodiment.

FIGS. 9 and 10 each show an exemplary illustrative non-limiting flowchart illustrating an exemplary processing procedure including the cut-out processing performed in the game device according to the present embodiment.

### DETAILED DESCRIPTION OF NON-LIMITING EXAMPLE EMBODIMENTS

The present embodiment will be described in detail with reference to the drawings. The same or corresponding elements in the drawings have the same reference characters allotted and description thereof will not be repeated.

Even when data is herein explained in identical terms, contents of the data do not have to completely match. In an example where both of one piece of data and another piece of data at least convey specific information, they may be regarded as the same data. A name of data is given for the sake of convenience, and does not limit the scope indicated by the data or the technical meaning thereof.

A program that causes a computer to perform processing herein may be a single program or a program group including a plurality of programs. “A program” in the present disclosure does not have to mean a single program but may include a program group. “A program” does not have to entirely be stored in a single apparatus. “A program” may mean, for example, the entirety of a plurality of programs stored in respective apparatuses included in a computer.

The “computer” herein does not necessarily mean a single apparatus but may encompass the entirety in which a plurality of apparatuses are connected by wired connection or wireless connection. In an example where the information processing apparatus is configured with a plurality of apparatuses, the entirety of the plurality of apparatuses may be an exemplary information processing apparatus or each of the plurality of apparatuses may be an exemplary information processing apparatus.

A “system” herein does not necessarily mean an assembly of a plurality of information processing apparatuses but may encompass a single information processing apparatus. The single information processing apparatus may be the “system” or the entirety of the plurality of information processing apparatuses may be the “system”.

### A. Exemplary System Configuration

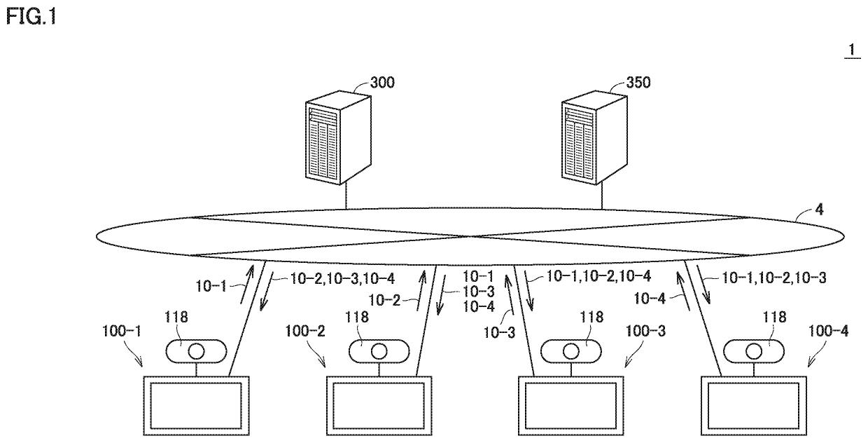

An exemplary configuration of a system 1 according to the present embodiment will be described with reference to FIG. 1. System 1 includes one or more game devices 100. Camera 118 is available in at least one of game devices 100. For example, game device 100 performs various types of processing by using camera data resulting from image capture by camera 118. The camera data is video data captured at a predetermined frame rate by way of example. The video data can also be said as an assembly of still image data. The video data captured by camera 118 is also referred to as “camera video” below. The camera video can also be paraphrased as images captured in real time by camera 118.

Camera 118 generates camera video resulting from image capture of a subject within a field of view, in accordance with a command from game device 100 or a predetermined condition. Camera 118 includes, for example, an image capture element such as a charge-coupled device (CCD) image sensor or a complementary metal oxide semiconductor (CMOS) image sensor. A lens may be arranged in a stage preceding the image capture element.

Game device 100 may be connected to camera 118 via a wired connection or a wireless connection. Camera 118 may be located outside game device 100 or may be a part of game device 100. A plurality of cameras 118 may be connectable to game device 100.

Camera 118 may be, for example, a camera for video chat. Camera 118 may be a dedicated camera connectable only to a specific device or a general-purpose camera connectable to any device. Game device 100 may use a camera of another information processing apparatus (for example, a smartphone). The configuration for game device 100 to use camera 118 is thus not limited. Game device 100 may obtain with any method, camera video captured by camera 118.

FIG. 1 shows an exemplary configuration of system 1 including four game devices 100 connected to a network 4. When each of a plurality of game devices 100 should be specified in the description below, a sub number will be given for distinction (for example, game devices 100-1, 100-2, 100-3, and 100-4 shown in FIG. 1).

In system 1, a user who uses game device 100 has the user's own account and the user's own account is brought in correspondence with each game device 100. The user who has the account can cause the account brought in correspondence to join one or more chat groups (which are also abbreviated as a “group” below) by providing predetermined input to game device 100. Game device 100 corresponding to the account belonging to at least one group streams data (which is also referred to as “communication data 10” below) to be used for communication between users to another game device 100 corresponding to another account belonging to the group. Communication between users can thus be realized in the group.

“Communication” or “chat” in the present embodiment may mean transmission of at least one of an image (which may include, for example, a game image, camera moving images, and a text image) and sound which may include voice to another game device 100. For example, unilateral transmission only of camera moving images of one game device 100 from one game device 100 to another game device 100 may also be encompassed in “chat” or “communication”. An account does not have to be brought in correspondence with each game device 100. The “account” may be read as the “game device” and vice versa.

Communication data 10 may include, for example, sound data obtained by game device 100, camera moving images obtained by game device 100, text data obtained by game device 100, information on an application running in game device 100, or the like. All pieces of data do not have to be included in one piece of communication data 10, and one piece of data may be divided into a plurality of pieces of communication data 10. One piece of communication data 10 may include a plurality of pieces of data.

System 1 may further include a management server 300 and a relay server 350. Management server 300 is responsible for processing for newly forming a group, processing for participation of one or more accounts in a group, or the like. Relay server 350 relays communication data 10 to be transmitted or received by one or more game devices 100. Management server 300 and relay server 350 may be implemented at a single physical server.

A scheme to stream communication data 10 from certain game device 100 to one or more other game devices 100 may be a scheme to directly stream communication data 10 to one or more other game devices 100 (for example, P2P or the like), in addition to or instead of a scheme to stream data through one or more relay entities (for example, relay server 350).

For example, game device 100-1 streams communication data 10-1 and receives communication data 10-2 to 10-4. Communication data 10 received by game device 100-1 may include at least a part of communication data 10-1 streamed by game device 100-1. For example, management server 300 or relay server 350 may generate and stream communication data 10 to be streamed to each game device 100 based on communication data 10 received from a plurality of game devices 100.

### B. Exemplary Hardware Configuration of Game Device 100

Game device 100 which is an exemplary information processing apparatus will now be described. The information processing apparatus is not limited to game device 100, and it may be, for example, a personal computer, a television, a tablet terminal, a smartphone, a wearable terminal, a server, or the like.

Game devices 100 corresponding to a plurality of accounts belonging to an identical group do not have to be identical in hardware configuration. For example, at least one of game devices 100 may be a device exclusive for games, and another game device 100 may be a personal computer, a television, a tablet terminal, a smartphone, a wearable terminal, a server, or the like capable of executing a game program. Game device 100 should only be a computer capable of executing at least a game program.

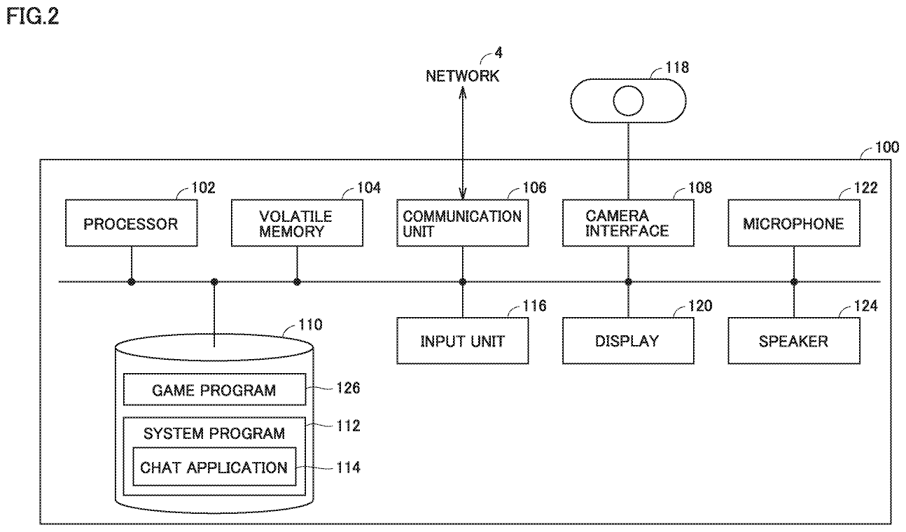

An exemplary hardware configuration of game device 100 will be described with reference to FIG. 2. Game device 100 includes, for example, one or more processors 102, one or more volatile memories 104, a communication unit 106, a camera interface 108, one or more non-volatile memories 110, an input unit 116, a display 120, a microphone 122, and a speaker 124. Each component may be removable from a main body of game device 100.

Processor 102 is a processing entity for performing processing in game device 100. Processor 102 includes, for example, a central processing unit (CPU), a graphics processing unit (GPU), or the like. Processor 102 develops a program stored in non-volatile memory 110 on volatile memory 104 and executes the same.

Volatile memory 104 is a volatile storage medium accessible by processor 102, and it includes, for example, a dynamic random access memory (DRAM), a static random access memory (SRAM), or the like.

Non-volatile memory 110 is a non-volatile storage medium accessible by processor 102, and it includes, for example, a flash memory, a hard disk, or the like. Non-volatile memory 110 may include, for example, a storage medium attachable to and removable from game device 100, such as a cartridge or an optical disc. Non-volatile memory 110 is also referred to as a storage.

For example, one or more programs such as a system program 112 and a game program 126 are stored in non-volatile memory 110.

System program 112 includes computer readable instructions for hardware control of game device 100, provision of a program execution environment, or the like. System program 112 may include one or more programs or program modules. For example, system program 112 includes a chat application 114.

Chat application 114 performs processing relating to transmission and reception of communication data 10 between a plurality of game devices 100 corresponding to a plurality of accounts belonging to a group.

Game program 126 includes computer readable instructions for performing game processing. A plurality of game programs 126 may be installed in game device 100. Game program 126 may be read from a separate storage medium. Another game device 100 or an external resource such as a server may be used for at least a part of execution of a game by game program 126. System program 112 may include at least a part of game program 126.

Game program 126 may be, for example, a communication type game in which a plurality of players can participate. For example, in an example where game program 126 is the communication type game, when game program 126 is executed together with chat application 114, running game program 126 may obtain camera video from another game device 100 via running chat application 114.

The “processor” herein may encompass at least processing circuitry that performs processing in accordance with computer readable instructions, such as a CPU or a GPU and hard-wired circuitry such as an application specific integrated circuit (ASIC) or a field programmable gate array (FPGA). The “memory” herein may encompass at least volatile memory 104 and non-volatile memory 110 and may include other storage media and storage devices.

In game device 100, a system on chip (SoC) in which functions of the processor, the memory, and the like are integrated may be adopted. In this case, the processor and the memory are located at the same SoC (integrated circuit). Therefore, the “processor” and the “memory” herein may at least encompass both of configurations independent of each other and an integrated configuration.

Communication unit 106 transmits and receives data to and from another game device 100, management server 300, relay server 350, or the like over network 4. Communication unit 106 may communicate data with another game device 100 or the like over the Internet as exemplary network 4. Network 4 may be a wireless network in conformity with Bluetooth®, ZigBee®, wireless LAN (IEEE 802.11), or the like.

Camera interface 108 mediates data transmission to camera 118 and data reception from camera 118. Connection of camera interface 108 to camera 118 may be wired connection or wireless connection.

Input unit 116 accepts a user operation. Input unit 116 includes, for example, a keyboard, a mouse, a game controller, a touch pad, and/or the like. Input unit 116 may be an interface with an apparatus (for example, a game controller) configured to accept a user operation. In other words, the apparatus configured to accept a user operation may be located outside game device 100.

Display 120 shows an image or a video image generated as a result of processing by processor 102. Display 120 includes, for example, a liquid crystal display (LCD), an organic EL display, or the like. Display 120 may be located outside game device 100. In this case, game device 100 may include an interface circuit with display 120.

Microphone 122 is arranged at a housing or the like of game device 100 and collects sound to generate a sound signal. Speaker 124 is arranged at the housing or the like of game device 100 and generates sound from a sound signal. At least one of microphone 122 and speaker 124 may be located outside game device 100.

### C. Exemplary Software Configuration of Game Device 100

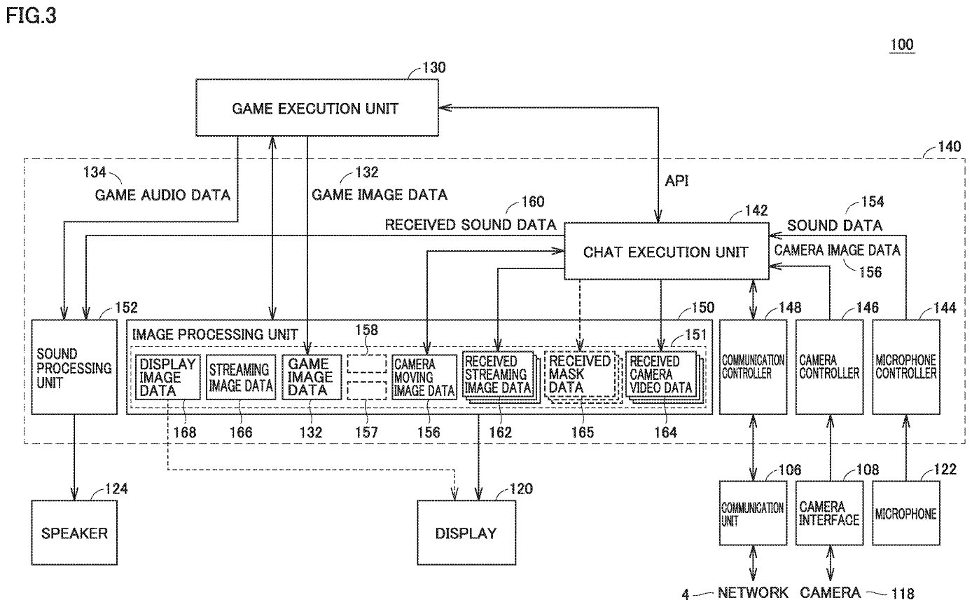

An exemplary software configuration of game device 100 will be described with reference to FIG. 3. In game device 100, system program 112 including chat application 114 and game program 126 are simultaneously executable. “Being simultaneously executable” means that a plurality of applications or programs are executed in parallel and does not limit execution timing or the like.

“Image data” herein encompasses data of moving images and data of one or more still images.

Game device 100 includes a system module 140 and a game execution unit 130 by way of example of a software component. System module 140 may be implemented by execution of system program 112 by one or more processors 102. System module 140 can also be referred to as running system program 112. Game execution unit 130 may be implemented by execution of game program 126 by one or more processors 102. Game execution unit 130 can also be referred to as running game program 126.

Game execution unit 130 proceeds with a game based on a user operation and outputs game image data 132 and game audio data 134. Game image data 132 may include, for example, a plurality of types of image data different in image quality, resolution, or frame rate.

System module 140 provides a basic function necessary in game device 100. System module 140 includes, for example, a chat execution unit 142. Chat execution unit 142 can also be referred to as running chat application 114.

System program 112 does not have to include at least a part of chat application 114. At least a part of chat application 114 may be an application different from system program 112, similarly to game program 126. In the description below, a part or the entirety of processing performed by system module 140 may be performed by chat execution unit 142. Therefore, in a context of processing performed by system module 140, system module 140 can also be read as chat execution unit 142 and system module 140 can also be read as system module 140 and chat execution unit 142.

System module 140 includes, for example, a microphone controller 144, a camera controller 146, a communication controller 148, an image processing unit 150, and a sound processing unit 152.

Microphone controller 144 generates sound data 154 based on sound collected by microphone 122 or the like.

Camera controller 146 generates camera video data 156 based on an image captured by camera 118 or the like. Camera controller 146 may be able to control start and stop or the like of image capture by camera 118, or to control a condition (a frame rate, white balance, or the like) for image capture by camera 118.

Communication controller 148 gives a command to communication unit 106 to control data communication with another game device 100 or the like.

Image processing unit 150 can use a storage area 151 for storage of image data. Storage area 151 may use, for example, a partial area of one or more volatile memories 104 or one or more non-volatile memories 110. Image processing unit 150 may be able to perform image processing on one or more pieces of image data.

Storage area 151 may include, for example, an area for storing game image data 132, camera video data 156, one or more pieces of received streaming image data 162, one or more pieces of received camera video data 164, streaming image data 166, and display image data 168.

Storage area 151 may further include an area for storage of cut-out video data 158. A specific area (for example, an area corresponding to a person) may be cut out from camera footage captured by camera 118 in accordance with a camera video display mode (which is also abbreviated as a “display mode” below) which will be described later. Processing for cutting out such a specific area is also referred to as “cut-out processing” below. Cut-out video data 158 is camera video that has been subjected to the cut-out processing. Cut-out video data 158 is used, for example, for generation of video resulting from cut-out of a person from camera footage.

Storage area 151 may further include an area for storage of mask data 157. Mask data 157 is data generated based on camera video data 156, the mask data indicating a specific area (for example, an area corresponding to a person) to be cut out. The cut-out processing may include processing for generating mask data 157.

Storage area 151 may further include an area for storage of one or more pieces of received mask data 165. Received mask data 165 is streamed from another game device 100 based on mask data 157 in another game device 100.

In the cut-out processing, at least one of cut-out video data 158 or mask data 157 may be generated. Details of the cut-out processing will be described later.

Chat execution unit 142 performs processing for communication between users in the group. For example, chat execution unit 142 may perform processing for joining or leaving the designated group in accordance with a user operation.

Chat execution unit 142 may generate communication data 10 based on at least one of sound data 154, streaming image data 166, camera video data 156, cut-out video data 158, and mask data 157 as processing for streaming communication data 10. Streaming image data 166 includes an image to be streamed to another game device 100.

Chat execution unit 142 may cause received streaming image data 162, received camera video data 164, and the like included in one or more pieces of communication data 10 from one or more other game devices 100 to be stored in storage area 151, as processing for receiving streaming communication data 10.

Received camera video data 164 is based on camera footage obtained by another game device 100 and captured by camera 118, and may be the same as camera video data 156 obtained by another game device 100 or the same as cut-out video data 158 generated in accordance with the display mode.

Chat execution unit 142 may output to sound processing unit 152, received sound data 160 included in one or more pieces of communication data 10 from one or more other game devices 100, as processing for receiving streaming data. Sound processing unit 152 may generate a sound signal based on sound data and output the generated sound signal to speaker 124.

Image processing unit 150 may generate display image data 168 based on at least one of game image data 132, camera video data 156, mask data 157, cut-out video data 158, one or more pieces of received streaming image data 162, one or more pieces of received camera video data 164, and one or more pieces of received mask data 165 in accordance with a command from chat execution unit 142. Display image data 168 is used for showing an image or a video image on display 120 of the device to which it belongs.

Chat execution unit 142 can cause game execution unit 130 to obtain video data or the like managed by chat execution unit 142, in response to a request from game execution unit 130. Interaction or the like of a request between chat execution unit 142 and game execution unit 130 may be realized by an application programming interface (API).

### D. Camera Video Display Mode

In game device 100, a plurality of display modes may be prepared in running chat application 114. The user can set or change the display mode, for example, on a setting screen of running chat application 114. The plurality of display modes may be different, for example, in degree of display of surroundings of a face of a person located within a field of view of camera 118. The surroundings of the face may include a part (for example, a body or the like) under the face. The degree of display may include, for example, whether to show an image, a degree of blur, or the like.

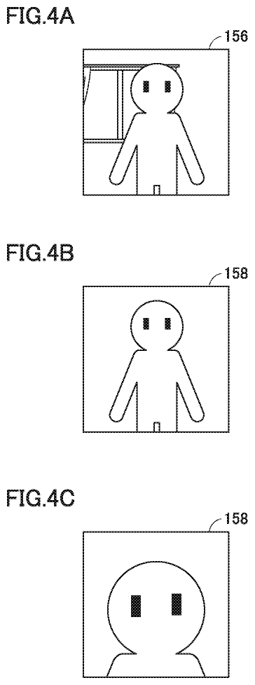

An exemplary camera video display mode in game device 100 will be described with reference to FIGS. 4A to 4C. FIGS. 4A to 4C exemplify three display modes by way of example.

FIG. 4A shows exemplary display in an example where a full-view mode is selected, by way of example of the display mode. Exemplary display shown in FIG. 4A is substantially identical to camera footage (for example, camera video data 156) captured by camera 118. It can also be said that a full view of the camera footage captured by camera 118 is used as it is. In the full-view mode, the surroundings of the face of the person in the camera footage captured by camera 118 is fully shown.

FIG. 4B shows exemplary display in an example where a body mode is selected, by way of example of the display mode. Exemplary display shown in FIG. 4B is such an image that only a person located within the field of view of camera 118 is cut out. Cut-out video data 158 may be data corresponding to FIG. 4B.

In the body mode, a background around the person in the image captured by camera 118 may be set to a specific color (for example, white) or a transparent color. In the body mode, it can also be said that the background in the surroundings of the face of the person is not shown. The image in the body mode may include the whole body or may include the face of the person and at least a part of the upper body (for example, a range above the navel). In an example where the image in the body mode includes the face and the part of the upper body, other portions of the body may be set to a specific color or a transparent color similarly to the background. Though one person is cut out in the exemplary display shown in FIG. 4B, in an example where a plurality of persons are located within the field of view of camera 118, the plurality of persons may be cut out.

FIG. 4C shows exemplary display in an example where a face mode is selected, by way of example of the display mode. In exemplary display shown in FIG. 4C, the face and the surroundings of the face of the person located within the field of view of camera 118 are cut out. Cut-out video data 158 may be data corresponding to FIG. 4C.

In the face mode, the face and the surroundings of the face of the person in the image captured by camera 118 may be cut out. The image captured by camera 118 may be enlarged as necessary. In the face mode, it can also be said that things other than the face of the person are not shown. The video in the face mode can also be paraphrased as including only the face. In the face mode, the background around the face of the person may be shown as it is or as being blurred away. Alternatively, the background around the face of the person may be set to a specific color (for example, white) or a transparent color.

Though three display modes are exemplified by way of example, the number of display modes is not limited and the display mode to be adopted is not limited either. For example, the display mode may include a mode in which the background in a full-view range is shown as being blurred away. In a modification, in each mode described above, rather than cutting out a quadrangular area, a circular or oval area may be cut out. Image data may include a frame of the cut-out area.

System module 140 may select the display mode based on a user operation. The cut-out processing when the body mode or the face mode is selected may be performed by at least one of camera controller 146, chat execution unit 142, and image processing unit 150 (see FIG. 3) or by a feature (for example, camera 118 or camera controller 146) other than that.

### E. Cut-Out Processing and Mask Data

In the body mode, the face mode, and the like described above, a specific area is cut out from camera footage captured by camera 118. The cut-out processing may include, for example, processing for specifying a contour of a person. Any algorithm may be used for the processing for specifying the contour of the person.

As described above, game device 100 may hold camera video data that has been subjected to the cut-out processing as cut-out video data 158, or may generate mask data 157 by performing the cut-out processing while game device 100 holds camera video data 156 captured by camera 118, as it is. Therefore, video data used for generation of cut-out video for a chat which result from cut-out of the person from camera footage may be cut-out video data 158 or a set of camera video data 156 and mask data 157.

Exemplary mask data 157 will be described below. Mask data 157 indicates, for example, an area of camera video to be shown and areas other than that.

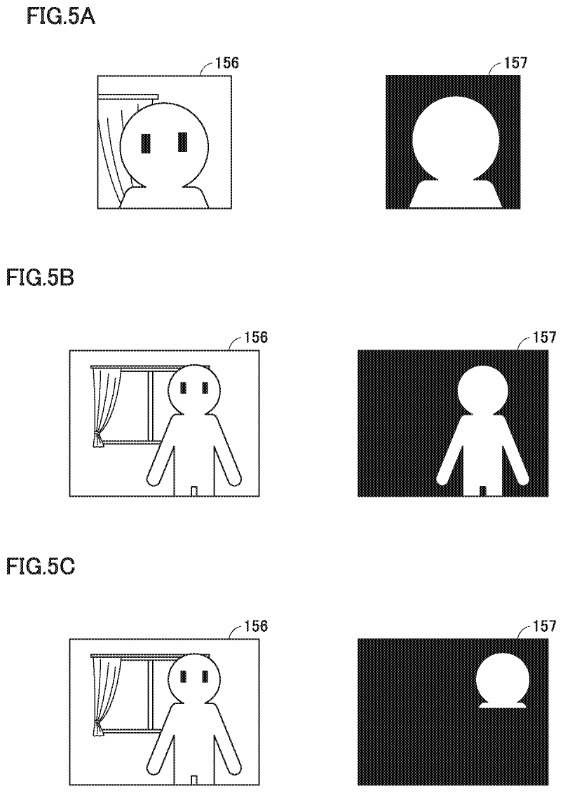

Exemplary mask data 157 in game device 100 will visually be explained with reference to FIGS. 5A to 5C.

FIG. 5A shows exemplary mask data 157 generated when the body mode is selected in an example where the surroundings of the face of the person is located within the field of view of camera 118. FIG. 5B shows exemplary mask data 157 generated when the body mode is selected in an example where the upper body of the person is located within the field of view of camera 118. FIG. 5C shows exemplary mask data 157 generated when the face mode is selected in an example where the upper body of the person is located within the field of view of camera 118.

Mask data 157 is generated in correspondence with camera video data 156. Mask data 157 may be generated based on the cut-out processing for cut-out along the contour of the person.

A position along the contour of the person may be located slightly outside the contour of the person and does not have to exactly abut on the contour of the person. For example, the area of the person indicated by mask data 157 may include an area outside by a predetermined distance from the contour of the person. Therefore, the area of the person indicated by mask data 157 may include the background of the person included in the camera data.

The area of the person indicated by mask data 157 may not only be generated based on the contour of the person but may be determined by any method.

In the examples shown in FIGS. 5A to 5C, mask data 157 has the number of pixels corresponding to the number of pixels in each frame of camera video data 156 and may be a kind of video data where a pixel to be shown is represented by “1” and a pixel other than that is represented by “0”. In other words, mask data 157 may be binary data (for example, “0” and “1”) indicating, for each pixel, whether the pixel should be shown.

Mask data 157 may be bicolor image data as in the examples shown in FIGS. 5A to 5C or it does not have to be in a format of image data. Mask data 157 may include information or the like on a ratio to be shown for each pixel or transparency of each pixel, in addition to or instead of information as to whether or not each pixel should be shown.

A resolution of mask data 157 may be equal to or lower than a resolution of camera video data 156. For example, one pixel of mask data 157 may correspond to two pixels×two pixels of camera video data 156. In this case, the resolution of mask data 157 is ¼ the resolution of camera video data 156.

A frame rate of mask data 157 may be equal to or lower than a frame rate of camera video data 156. For example, the frame rate of mask data 157 may be a fraction of an integer (for example, ½ or the like) of the frame rate of camera video data 156.

Running chat application 114 may realize display as shown in FIG. 4B or 4C based on cut-out video data 158 or the set of camera video data 156 and mask data 157. Running game program 126 may also perform processing in accordance with progress of a game based on cut-out video data 158 or the set of camera video data 156 and mask data 157.

Game device 100 may stream camera video data 156 to another game device 100, as a part of communication data 10. Game device 100 may stream cut-out video data 158 instead of or in addition to camera video data 156 to another game device 100.

Game device 100 may receive from another game device, received mask data 165 in addition to received camera video data 164. At least one of running chat application 114 or running game program 126 may realize display as shown in FIG. 4B or 4C based on received camera video data 164 and received mask data 165.

As described above, in the cut-out processing, mask data is not essential. For example, in an example where game device 100 streams cut-out video data 158 to another game device 100, it does not have to stream mask data 157. Similarly, in an example where game device 100 receives cut-out video data 158 as received camera video data 164 from another game device 100, it does not have to receive received mask data 165.

An algorithm for the cut-out processing does not have be the same between game devices 100 that have joined the identical group, and whether or not to use the mask data may also be different between game devices 100.

### F. Exemplary Chat Screen

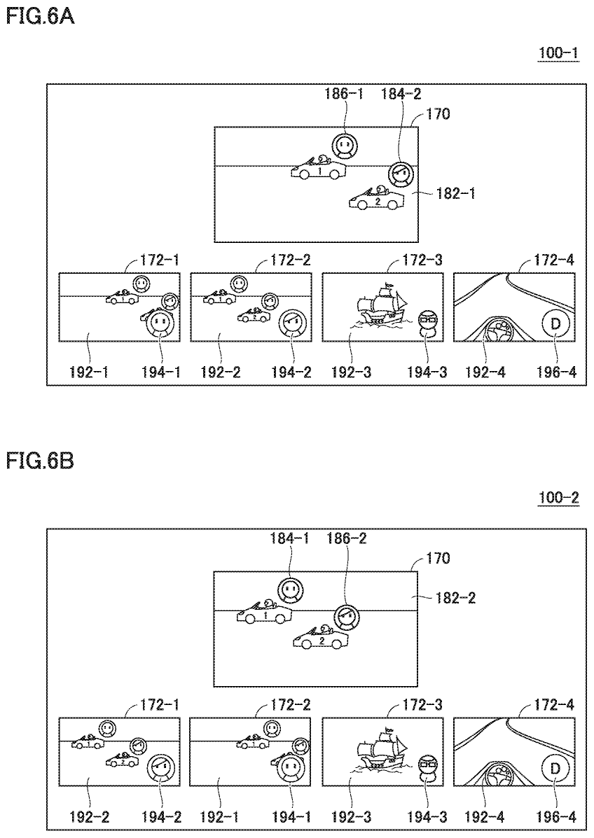

An exemplary chat screen generated in game device 100 will be described with reference to FIGS. 6A and 6B. The chat screens shown in FIGS. 6A and 6B are mainly generated by running chat application 114.

By way of example, four accounts belong to an identical group and game devices 100-1 to 100-4 correspond to the four respective accounts as shown in FIG. 1. It is assumed in FIGS. 6A and 6B that game devices 100-1 to 100-3 are streaming camera video and game device 100-4 is not streaming camera video by way of example.

It is assumed that a player 1 and a player 2 are participating in a communication type game from game device 100-1 and game device 100-2, respectively. At this time, each of game device 100-1 and game device 100-2 generates a game image. One game device 100 may generate the game image and stream the generated game image to the other game device 100.

FIG. 6A shows an exemplary chat screen shown on display 120 of game device 100-1 and FIG. 6B shows an exemplary chat screen shown on display 120 of game device 100-2. The chat screens shown in FIGS. 6A and 6B are by way of example and a screen configuration of the chat screen created by using communication data 10 is not limited.

As shown in FIG. 6A, in a display area 170 in the exemplary chat screen of game device 100-1, a game image 182-1 generated by running game program 126 at game device 100-1 is shown. For example, game image 182-1 is shown based on game image data 132 shown in FIG. 3. In display areas 172-1 to 172-4 in the exemplary chat screen of game device 100-1, streaming images 192-1 to 192-4 transmitted by game devices 100-1 to 100-4 are shown, respectively.

In this example, game device 100-1 is transmitting streaming image 192-1 including game image 182-1 to game devices 100-2 to 100-4. In addition, game device 100-1 receives received streaming image data 162 from each of game devices 100-2 to 100-4 and shows streaming images 192-2 to 192-4.

In-chat camera videos 194-1 to 194-3 streamed by game devices 100-1 to 100-3 are superimposed on streaming images 192-1 to 192-3, respectively. Since game device 100-4 is not streaming camera video, on the other hand, an icon image 196-4 indicating the account corresponding to game device 100-4 is superimposed on streaming image 192-4.

Running chat application 114 generates in-chat camera video 194-1 corresponding to the account of game device 100-1 based on cut-out video data 158 or the set of camera video data 156 and mask data 157. In addition, running chat application 114 generates in-chat camera videos 194-2 and 194-3 based on received camera video data 164 or a set of received camera video data 164 and received mask data 165 received from game devices 100-2 and 100-3, respectively. In-chat camera videos 194-2 and 194-3 correspond to the accounts of game devices 100-2 and 100-3, respectively.

In the chat screens shown in FIGS. 6A and 6B described above, the users of game devices 100-1 and 100-2 have selected the face mode and the user of game device 100-3 has selected the body mode.

In game image 182-1 shown in FIG. 6A, in-game camera video 186-1 and in-game camera video 184-2 are superimposed. Running game program 126 generates in-game camera video 186-1 based on cut-out video data 158 or the set of camera video data 156 and mask data 157 and generates in-game camera video 184-2 based on received camera video data 164 (or the set of received camera video data 164 and received mask data 165) received from game device 100-2. Running game program 126 generates game image 182-1 including in-game camera video 186-1 and in-game camera video 184-2.

Running game program 126 may generate in-game camera video 186-1 by cutting out a specific area (for example, an area located inside the contour of the person) based on mask data 157.

As shown in FIG. 6B, in display area 170 in the exemplary chat screen of game device 100-2, a game image 182-2 of a game program running at game device 100-2 is shown. In display areas 172-1 to 172-4 in the exemplary chat screen of game device 100-2, streaming images 192-1 to 192-4 transmitted by game devices 100-1 to 100-4 are shown, respectively. The order of display of the streaming images may be different from that in the exemplary chat screen of game device 100-1 shown in FIG. 6A.

Game device 100-2 performs processing as in game device 100-1 described above. For example, in game image 182-2 shown in FIG. 6B, in-game camera video 186-2 and in-game camera video 184-1 are superimposed. Game program 126 running in game device 100-2 generates in-game camera video 186-2 based on cut-out video data 158 or the set of camera video data 156 and mask data 157 and generates in-game camera video 184-1 based on received camera video data 164 (or the set of received camera video data 164 and received mask data 165) received from game device 100-1.

In-chat camera video 194 herein mean various images generated based on camera footage from game device 100 that transmits a streaming image 192. A size or a shape of in-chat camera video 194 is not limited, and a form of use of in-chat camera video 194 in the streaming image is not limited either. When a specific display mode (for example, the body mode or the face mode) is selected in running chat application 114, in-chat camera video 194 show video resulting from cut-out of the person from camera footage.

In-game camera video herein mean various videos generated by running game program 126, based on at least one of camera footage obtained in a subject game device 100 or camera footage obtained from another game device 100. A size or a shape of in-game camera video is not limited, and a form of use of in-game camera video in a game image 182 is not limited either. When a specific display mode (for example, the body mode or the face mode) is selected in running chat application 114, in-game camera video shows video resulting from cut-out of the person from camera footage. Even when the display mode where the background is included in the image is selected in running chat application 114, running game program 126 may generate in-game camera video showing video resulting from cut-out of the person from camera footage.

In-game camera video 186 is video based on footage captured by camera 118 available to game device 100 where game program 126 is executed. In-game camera video 184 is video based on received camera video data 164 obtained by game device 100 that executes game program 126, from another game device 100 with which game device 100 communicates while chat application 114 is running.

### G. Positional Information

In the communication type game, the user who joins the game may be able to set a range within camera footage the user desires to use in the game.

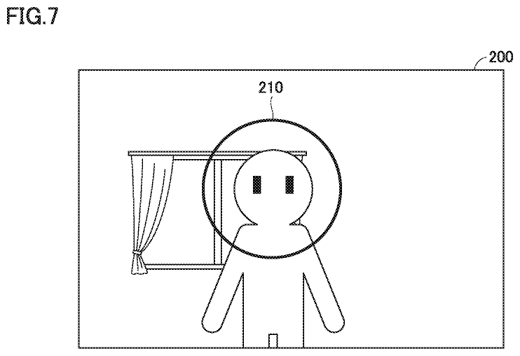

An exemplary setting screen 200 provided in game device 100 will be described with reference to FIG. 7. Setting screen 200 is used, for example, for setting for using camera footage in the game provided by execution of game program 126. In an example where game program 126 generates setting screen 200, setting screen 200 can also be said as the game image.

In setting screen 200, camera footage captured by camera 118 are shown. In setting screen 200, by way of example, a pointer 210 is shown together with the camera footage. Pointer 210 may be used for designating a range of display of the camera footage.

Though a circular frame indicating the display range is shown by way of example of pointer 210, any shape of the frame may be applicable. Pointer 210 may be, for example, a frame exhibiting any polygonal shape (for example, a quadrangular shape), an oval shape, or any shape a part of which is open.

Pointer 210 moves in accordance with a user operation. When a predetermined operation is performed or a predetermined condition is satisfied, a position of pointer 210 is set. Game device 100 generates positional information indicating the set position of pointer 210.

The positional information includes information on camera footage that is necessary for generation of video to be used in the game. The positional information may include a coordinate (for example, a set of an X coordinate and a Y coordinate) indicating the position (for example, a central point of the frame) of the pointer or a plurality of coordinates defining the frame indicated by the pointer. The positional information may include information (for example, a radius of the frame) indicating the size of the frame. The positional information may include information (for example, a quadrangular shape, a hexagonal shape, or the like) indicating the shape of the frame.

In the game, camera footage is used based on the generated positional information. Processing based on the positional information may be cutting out a part of camera footage as it is, cutting out a part of camera footage and then performing some kind of image processing thereon, or performing some kind of image processing on camera footage and then cutting out a part of the camera footage.

In an example where chat application 114 and the communication type game (exemplary game program 126) are simultaneously running, running game program 126 can transmit the positional information to game program 126 running in another game device 100 that has joined the communication type game. At this time, the positional information may be exchanged between running game programs 126, not via chat application 114.

When running game program 126 obtains the positional information from game program 126 running in another game device 100, it generates in-game camera video of another game device 100 based on received camera video data 164 (or received camera video data 164 and received mask data 165) from another game device 100 obtained via chat application 114 and the obtained positional information.

Game program 126 thus obtains received camera video data 164 and the positional information from each of one or more other game devices 100 and generates in-game camera video of the each of one or more other game devices 100 by using the obtained positional information.

In an example where chat application 114 is not running but game program 126 is running as well, game device 100 may receive camera video data 156 and the positional information from another game device 100 and generate in-game camera video by cut-out from camera video data 156.

### H. Quality of Display of Camera Video that Has Been Subjected to Cut-Out Processing

In an example where chat application 114 and game program 126 are simultaneously running in game device 100, when a specific display mode (for example, the body mode or the face mode) is selected in running chat application 114, camera footage captured by camera 118 is subjected to the cut-out processing. Running game program 126 generates in-game camera video based on camera video that has been subjected to the cut-out processing (for example, cut-out video data 158 or camera video data 156 and mask data 157), with progress of the game.

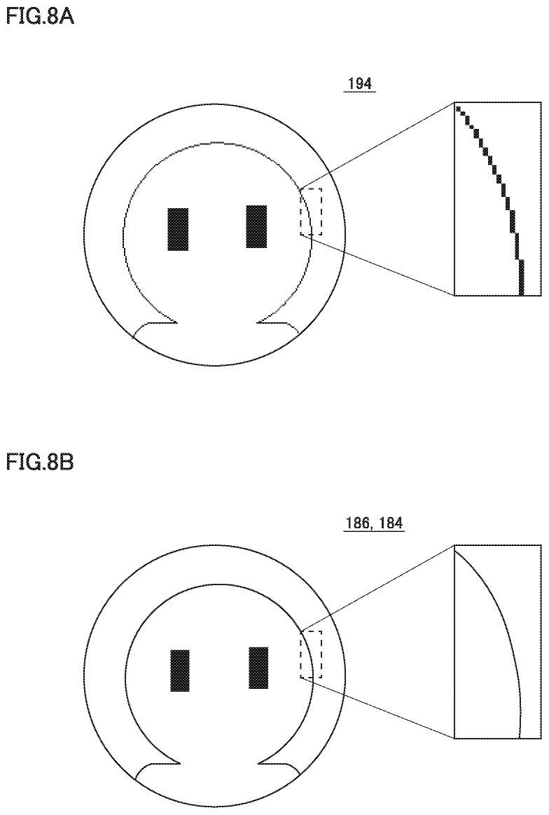

Exemplary camera video that has been subjected to the cut-out processing in game device 100 will be described with reference to FIGS. 8A and 8B. FIG. 8A shows exemplary in-chat camera video 194 generated by running chat application 114. FIG. 8B shows exemplary in-game camera video 186 generated by running game program 126. In-game camera video 184 is also similar to in-game camera video 186 shown in FIG. 8B.

Based on comparison between FIGS. 8A and 8B, jagged artifacts along the contour of the person are suppressed in in-game camera video 186 shown in FIG. 8B relative to in-chat camera video 194 shown in FIG. 8A. In-game camera videos 186 and 184 shown while game program 126 is running are thus video where jagged artifacts along the contour of the person are suppressed more than in in-chat camera video 194 shown while chat application 114 is running.

By way of example, in game device 100, resources allocated to chat application 114 may be restricted in order to secure resources to be allocated to game program 126. At this time, the cut-out processing by running chat application 114 is desirably light in processing load.

In game program 126, on the other hand, for which the allocated resources are to be used can be determined with progress of the game. Therefore, running game program 126 may use the allocated resources as necessary to generate in-game camera video where jagged artifacts are further suppressed. Good user experiences are thus provided.

Game execution unit 130 may adjust resources to be used for processing for suppressing jagged artifacts with progress of the game or may temporarily stop the processing for suppressing jagged artifacts. For example, when in-game camera video is large in size as in an example where the size of in-game camera video within the game image is larger than a predetermined value by way of example, processing for suppressing jagged artifacts may be performed. In an example where a plurality of series of in-game camera video are generated, a level of quality or an algorithm may be different between processing for suppressing jagged artifacts for at least one series of in-game camera videos and processing for suppressing jagged artifacts for another series of in-game camera videos.

Running chat application 114 may also perform the processing for suppressing jagged artifacts. Jagged artifacts may be suppressed more in in-game camera video on which game program 126 has performed the processing for suppressing jagged artifacts than in in-chat camera video on which chat application 114 has performed the processing for suppressing jagged artifacts.

By way of example, while running chat application 114 has to communicate various types of data for executing a chat, an amount of communication relating to data necessary for generation of in-chat camera video may have to be suppressed. At this time, it may be difficult to transmit or receive cut-out video data 158 where jagged artifacts are sufficiently suppressed or mask data 157 with which jagged artifacts can sufficiently be suppressed. Running game program 126, on the other hand, may not require transmission and reception of cut-out video data 158 or mask data 157, or may have secured a sufficient amount of communication for transmission and reception of cut-out video data 158 or mask data 157. Therefore, running game program 126 may generate in-game camera video where jagged artifacts are relatively further suppressed. Good user experiences are thus provided.

By way of example, the display area for in-chat camera video shown in running chat application 114 may be small. By way of example, the area where in-chat camera video can be shown may be determined in advance. For example, in the exemplary chat screens shown in FIGS. 6A and 6B described above, in-chat camera video 194 are shown in a partial area within each of display areas 172-1 to 172-4. Therefore, chat application 114 may not perform the processing for suppressing jagged artifacts or may perform the processing for suppressing jagged artifacts relatively low in degree of suppression. The display area for in-game camera video, on the other hand, may relatively be large. For example, in the exemplary chat screens shown in FIGS. 6A and 6B described above, display area 170 for game image 182 including in-game camera video 186 or in-game camera video 184 is larger than each of display areas 172-1 to 172-4 where in-chat camera video 194 may be included. The size or the position of the display area for in-game camera video 184 within game image 182 may vary with progress of game program 126. Therefore, game program 126 may generate in-game camera video where jagged artifacts are relatively further suppressed. Good user experiences are thus provided.

A technique to evaluate the degree of suppression of jagged artifacts is not limited. For example, the degree of suppression of jagged artifacts may be evaluated based on the size of a pixel around the contour, smoothness of transition of the color or transparency of pixels adjacent around the contour, whether jagged artifacts are visually observed, or the like.

Any algorithm may be used for the processing for suppressing jagged artifacts. For example, jagged artifacts can be suppressed by determining the color of each pixel from the color of pixels nearby.

For example, in an example where mask data 157 includes information on transparency of each pixel, jagged artifacts may be suppressed based on the information. Transparency of each pixel is calculated based on pixels nearby. Jagged artifacts can be suppressed by using transparency corresponding to rendering of a contour part of the person.

When the resolution of mask data 157 is lower than the resolution of camera video data 156, one pixel of mask data 157 corresponds to a plurality of pixels of camera video data 156. Therefore, when in-chat camera video or in-game camera video is generated based on camera video data 156 and mask data 157, occurrence of jagged artifacts is more likely.

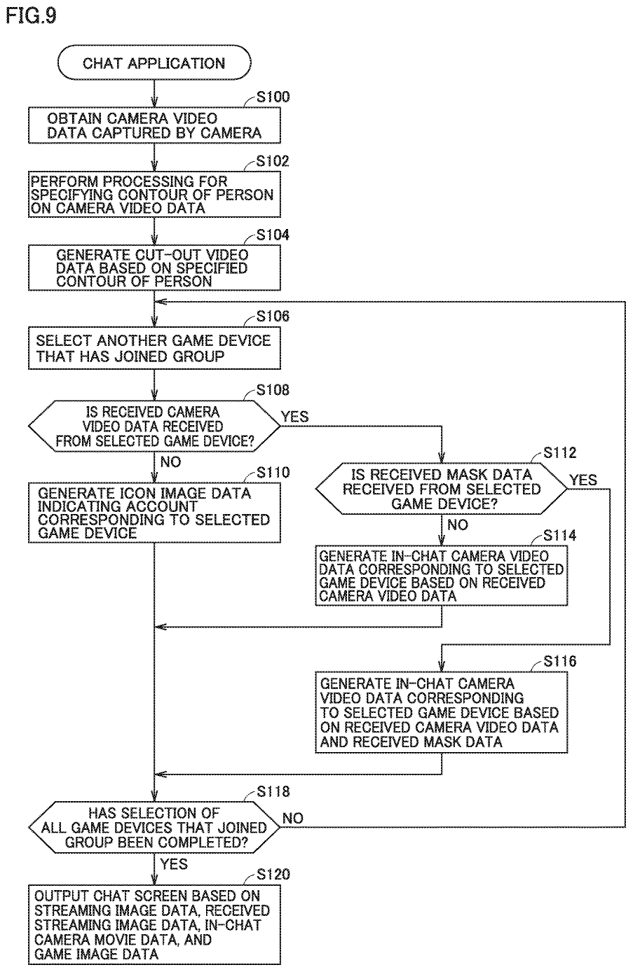

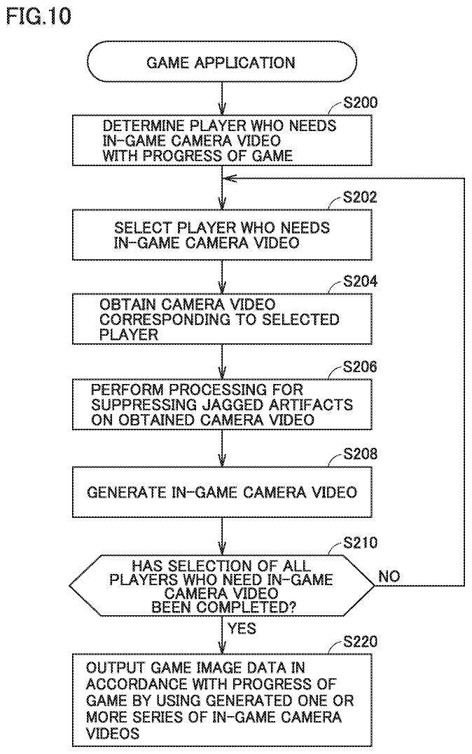

An exemplary processing procedure including the cut-out processing performed in game device 100 will be described with reference to FIGS. 9 and 10. As premises of processing shown in FIGS. 9 and 10, it is assumed, for example, that chat application 114 and game program 126 are simultaneously running and game program 126 is a communication type game. It is assumed that, in running chat application 114, a display mode (for example, the body mode or the face mode) that requires the cut-out processing has been selected. The display mode that requires the cut-out processing may have been selected in running chat application 114 also in another game device 100.

Each step shown in FIG. 9 may be performed by execution of system program 112 including chat application 114 by one or more processors 102. Each step shown in FIG. 10 may be performed by execution of game program 126 by one or more processors 102.

The processing in FIGS. 9 and 10 is repeatedly performed at predetermined intervals (for example, at intervals corresponding to frames of processing performed every 1/60 second) by way of example. This is also similar in the description which will follow.

Processing described in the present embodiment may include other types of processing or does not have to include a part of processing. The order of performing processing is by way of example. For example, a plurality of types of processing may be performed in parallel, or some processing may be performed in the order reverse to the order in the description. Though processing is divided in units of steps for the sake of convenience of description, any unit of division may be applicable. A plurality of steps may be integrated, or a single step may be divided into a plurality of steps. This is also similar in the description which will follow.

Referring to FIG. 9, system module 140 obtains camera video data 156 captured by camera 118 (step S100). System module 140 performs processing for specifying the contour of the person on obtained camera video data 156 (step S102). System module 140 generates cut-out video data 158 based on the specified contour of the person (step S104).

In step S104, system module 140 may generate mask data 157 based on the specified contour of the person, instead of or in addition to generation of cut-out video data 158.

System module 140 selects another game device 100 that has joined the group (step S106) and determines whether or not it receives received camera video data 164 from selected game device 100 (step S108).

When system module 140 does not receive received camera video data 164 (NO in step S108), it generates icon image data (see, for example, icon image 196-4 in FIGS. 6A and 6B) indicating the account corresponding to selected game device 100 (step S110).

When system module 140 receives received camera video data 164 (YES in step S108), it determines whether or not it receives received mask data 165 from selected game device 100 (step S112).

When system module 140 does not receive received mask data 165 (NO in step S112), it generates in-chat camera video data corresponding to selected game device 100 based on received camera video data 164 (step S114). In step S114, system module 140 does not perform the cut-out processing on received camera video data 164. Received camera video data 164 may be camera video that has been subjected to the cut-out processing.

When system module 140 receives received mask data 165 (YES in step S112), it generates in-chat camera video data corresponding to selected game device 100 based on received camera video data 164 and received mask data 165 (step S116). In step S116, system module 140 performs the cut-out processing on received camera video data 164 based on received mask data 165.

System module 140 determines whether or not selection of all game devices 100 that joined the group has been completed (step S118). When selection of all game devices 100 that joined the group has not been completed (NO in step S118), processing in step S106 or later is repeated.

When selection of all game devices 100 that joined the group has been completed (YES in step S118), system module 140 outputs the chat screen based on streaming image data 166, one or more pieces of received streaming image data 162, generated one or more pieces of in-chat camera video data, and game image data 132 generated by game execution unit 130 (step S120).

Referring to FIG. 10, game execution unit 130 determines a player who needs in-game camera video with progress of the game (step S200). For example, in-game camera video may be shown only for another player present within a game field of view of the player corresponding to game device 100. In an example where a player who needs in-game camera video is determined in advance, processing in step S200 may be skipped.

Game execution unit 130 selects a player who needs in-game camera video (step S202) and obtains camera video corresponding to the selected player (step S204). The obtained camera video may be, for example, at least one of cut-out video data 158, the set of camera video data 156 and mask data 157, received camera video data 164, or the set of received camera video data 164 and received mask data 165.

Game execution unit 130 performs the processing for suppressing jagged artifacts on the obtained camera video (step S206) to generate in-game camera video (step S208).

As described above, when the display mode that requires the cut-out processing has been selected, camera video obtained by game execution unit 130 in step S204 is camera video resulting from cut-out of the area of the person from camera video data 156. Game execution unit 130 generates in-game camera video shown while game program 126 is running, based on the obtained camera footage. The generated in-game camera video is also camera video resulting from cut-out of the area of the person from camera video data 156.

In an example where the set of camera video data 156 and mask data 157 is obtained, game execution unit 130 may cut out the area of the person from camera video data 156 based on mask data 157 and then perform the processing for suppressing jagged artifacts. This is also applicable to the example where the set of received camera video data 164 and received mask data 165 is obtained.

In an example where mask data 157 or received mask data 165 includes information on transparency of each pixel, game execution unit 130 may perform the processing for suppressing jagged artifacts based on the information on the transparency included in mask data 157 or received mask data 165.

In an example where game execution unit 130 obtains the positional information from another game device 100 corresponding to the selected player, in step S208, it may cut out the specific area based on the positional information prior to the processing for suppressing jagged artifacts. More specifically, game execution unit 130 generates yet-to-be-corrected video from which the person has been cut out, the yet-to-be-corrected video corresponding to the display range indicated by the positional information, based on received camera video data 164 or on the set of received camera video data 164 and received mask data 165. Game execution unit 130 may then perform the processing for suppressing jagged artifacts on the generated yet-to-be-corrected video to generate in-game camera video.

By generating yet-to-be-corrected video corresponding to the display range indicated by the positional information and then performing the processing for suppressing jagged artifacts, a portion where jagged artifacts should be suppressed can appropriately be processed.

Game execution unit 130 determines whether or not selection of all players who need in-game camera video has been completed (step S210). When selection of all players who need in-game camera video has not been completed (NO in step S210), processing in step S202 or later is repeated.

When selection of all players who need in-game camera video has been completed (YES in step S210), game execution unit 130 outputs game image data 132 in accordance with progress of the game by using generated one or more series of in-game camera video (step S212). In step S212, game execution unit 130 determines the position of a game object or updates various parameters in accordance with a user operation.

### I. Modification

Game device 100 may receive from another game device 100, received camera video data 164 not accompanying received mask data 165, rather than cut-out video data 158. By way of example, received camera video data 164 may be video data indicating video including the person and the background. Game device 100 may then obtain information indicating the display mode of another game device 100 and perform the cut-out processing on received camera video data 164. Game device 100 may generate mask data or perform the cut-out processing with a different technique. Running chat application 114 may use in-chat camera video to which the cut-out processing has been applied.

Running game program 126 may obtain received camera video data 164 not accompanying mask data 157 rather than cut-out video data 158. Running game program 126 may perform the cut-out processing on obtained received camera video data 164. Running game program 126 may generate mask data or perform the cut-out processing with a different technique. Running game program 126 may generate a game image including in-game camera video to which the cut-out processing has been applied.

Running game program 126 may obtain from chat application 114, cut-out video data 158 or mask data 157 to which jaggy suppression processing by chat application 114 has been applied. Running game program 126 may generate in-game camera video in which jagged artifacts are further suppressed, based on obtained cut-out video data 158 or the set of camera video data 156 and mask data 157.

### J. Other Embodiments

Though an example where cut-out video data 158 used in running chat application 114 is used also in running game program 126 is shown in the description above, cut-out video data 158 may be used in one or more other applications, without being limited to game program 126. In this case again, other applications may perform the processing for suppressing jagged artifacts.

Though an example in which a plurality of users are executing the communication type game is described for the sake of convenience of description, the present disclosure is applicable also off-line and applicable to an example where a single user is playing a game.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage media having stored therein instructions for game processing that, when executed, cause one or more processors to perform operations comprising:
obtaining chat camera video data to be used for generation of chat cut-out video resulting from cut-out of a person from camera footage, the chat cut-out video being shown while a chat application is running; and
generating game cut-out video resulting from cut-out of the person from the camera footage based on the chat camera video data, the game cut-out video being shown while a game program is running, wherein
jagged artifacts along a contour of the person are suppressed in the game cut-out video relative to the chat cut-out video.

2. The one or more non-transitory computer-readable storage media according to claim 1, wherein
the game cut-out video is based on footage captured by a camera available to an information processing apparatus that executes the instructions.

3. The one or more non-transitory computer-readable storage media according to claim 1, wherein
the game cut-out video is based on chat camera video data obtained by an information processing apparatus that executes the instructions, from another information processing apparatus with which the information processing apparatus communicates while the chat application is running.

4. The one or more non-transitory computer-readable storage media according to claim 3, wherein
the operations comprise:
obtaining positional information from the another information processing apparatus;
generating, based on the chat camera video data, yet-to-be-corrected video from which the person has been cut out, the yet-to-be-corrected video corresponding to a display area indicated by the positional information; and
generating the game cut-out video by performing processing for suppressing jagged artifacts on the yet-to-be-corrected video.

5. The one or more non-transitory computer-readable storage media according to claim 1, wherein
a display area for a game image including the game cut-out video is larger than each display area for the chat cut-out video.

6. A system comprising:
one or more processors; and
one or more memories having stored therein instructions for game processing that, when executed, cause the system to perform operations comprising
obtaining chat camera video data showing chat cut-out video resulting from cut-out of a person from camera footage, the chat cut-out video being shown while a chat application is running, and
generating a game cut-out video resulting from cut-out of the person from the camera footage based on the chat camera video data, the game cut-out video being shown while a game program is running, wherein
jagged artifacts along a contour of the person are suppressed in the game cut-out video relative to the chat cut-out video.

7. The system according to claim 6, wherein
the game cut-out video are based on footage captured by a camera available to the system.

8. The system according to claim 6, wherein
the game cut-out video is based on chat camera video data obtained by the system from another information processing apparatus with which the system communicates while the chat application is running.

9. The system according to claim 8, wherein
the operations comprise
obtaining positional information from the another information processing apparatus,
generating, based on the chat camera video data, yet-to-be-corrected video from which the person has been cut out, the yet-to-be-corrected video corresponding to a display area indicated by the positional information, and
generating the game cut-out video by performing processing for suppressing jagged artifacts on the yet-to-be-corrected video.

10. The system according to claim 6, wherein
a display area for a game image including the game cut-out video is larger than each display area for the chat cut-out video.

11. A computer-implemented method comprising:
performing game processing in accordance with a game program;
obtaining chat camera video data showing chat cut-out video resulting from cut-out of a person from camera footage, the chat cut-out video being shown while a chat application is running; and
generating a game cut-out video resulting from cut-out of the person from the camera footage based on the chat camera video data, the game cut-out video being shown while the game program is running, wherein
jagged artifacts along a contour of the person are suppressed in the game cut-out video relative to the chat cut-out video.

12. The computer-implemented method according to claim 11, wherein
the game cut-out video is based on footage captured by a camera available to a computer.

13. The computer-implemented method according to claim 11, wherein
the game cut-out video is based on chat camera video data obtained by a computer from another computer with which the computer communicates while the chat application is running.

14. The computer-implemented method according to claim 13, further comprising:
obtaining positional information from the another computer;
generating, based on the chat camera video data, yet-to-be-corrected video from which the person has been cut out, the yet-to-be-corrected video corresponding to a display area indicated by the positional information; and
generating the game cut-out video by performing processing for suppressing jagged artifacts on the yet-to-be-corrected video.

15. The computer-implemented method according to claim 11, wherein
a display area for a game image including the game cut-out video is larger than each display area for the chat cut-out video.
